(19) United States
(12) Patent Application Publication
(10) Pub. No.: US 2013/0216995 A1
(43) Pub. Date: Aug. 22, 2013

(54) METHOD, APPARATUS AND SYSTEM FOR LEARNING PLAN ANALYSIS

(71) Applicants: Gi Bum Yoon, Seoul (KR); Yong Zee Koh, Gyeonggi-do (KR); Don Jeong Kim, Seoul (KR); Dong Hun Kim, Seoul (KR); Jong Phil Bae, Seoul (KR); Young Jin Ahn, Gyeonggi-do (KR); Kee Yeon Lee, Seoul (KR); Jeong Sik Coh, Seoul (KR)

(72) Inventors: Gi Bum Yoon, Seoul (KR); Yong Zee Koh, Gyeonggi-do (KR); Don Jeong Kim, Seoul (KR); Dong Hun Kim, Seoul (KR); Jong Phil Bae, Seoul (KR); Young Jin Ahn, Gyeonggi-do (KR); Kee Yeon Lee, Seoul (KR); Jeong Sik Coh, Seoul (KR)

(73) Assignee: SK TELECOM CO., LTD., Seoul (KR)

(21) Appl. No.: 13/818,880

(22) PCT Filed: Jun. 22, 2011
(86) PCT No.: PCT/KR2011/004552

§ 371 Date: May 6, 2013

(30) Foreign Application Priority Data
Aug. 25, 2010 (KR) 10-2010-0082364

(51) Int. Cl. G09B 5/00

(52) U.S. Cl. CPC G09B 5/00
USPC 434/365

(57) ABSTRACT

The present invention relates to a method, apparatus and system for learning plan analysis. According to one embodiment of the present invention, the method for learning plan analysis includes: providing a learner with learning materials commensurate with a learning progress or learning ability; receiving learning information responsive to the learning materials; and generating analysis data from analyzing interaction patterns of a user in learning.

### TECHNICAL FIELD

The present disclosure relates in some embodiments to a method, apparatus and system for analyzing learning plans. More particularly, the present disclosure relates to a method, apparatus and system for analyzing learning plans which provide optimized learning conditions to individual learners at learning sessions by feeding analyzed learning attitudes back to the learners.

### BACKGROUND

The statements in this section merely provide background information related to the present disclosure and may not constitute prior art.

Traditionally, a method for feedback of a learner's learning results analyzes subjects or chapters of low performance and presents notes for the wrong answers to the learner. It provides questions relevant to the weak subjects or chapters for the learner to strengthen his weak points. According to an alternative method, a learner obtains an assignment posted online and submits his answers to the problems and a server in turn evaluates the homework and provides analysis data including an analysis on missed problems.

When such methods are utilized, the learner is provided with a personal achievement attained from the learning topic, learning subject or chapters, or other learners' outputs or learning plans are compared against in a comparative process. The methods, however, operate based on the resultant performances of the problem solving and failed to consider other factors. This has laid certain constraints on seeking further improvements which could double the learning efficiency.

### DISCLOSURE

### Technical Problem

The present disclosure aims to solve the aforementioned problems and establish such an environment for feeding an analysis result from collecting and analyzing an interaction pattern of a learner at a learning session back to the learner to present a personalized and optimized learning condition. In addition, the present disclosure aims to establish such an environment for enabling to provide learning conditions considering more extra factors than a single interaction pattern by combining correlations between multiple interaction patterns or correlations between extra factors besides the interaction patterns as well as incorporating temporal factors of the interaction patterns to compute analysis data toward providing the learner with the right learning condition more effectively.

### SUMMARY

An embodiment of the present disclosure provides system for analyzing a learning plan, the system including: a terminal for receiving learning materials and generating a learning information; and a server for providing the terminal with the learning materials commensurate with a learning progress or learning ability, receiving the learning information responsive to the learning materials and then generating analysis data by analyzing interaction patterns of learning by a user for the learning information.

In addition, another embodiment of the present disclosure provides an apparatus for analyzing a learning plan, the apparatus including: a material provider for providing learning materials commensurate with a learning progress or learning ability through a predetermined terminal; a learning information receiver for receiving learning information responsive to the learning materials; and a pattern analyzer for generating analysis data from analyzing interaction patterns of a user in the course of learning, contained in the learning information.

The apparatus for analyzing the learning plan may includes an evaluator for calculating evaluation data of the user in the course of learning by automatically evaluating learning outputs included in the learning information based on a predetermined evaluation criterion.

The analysis data may be calculated by combining a correlation between the interaction patterns and the evaluation data.

The interaction patterns may generate one or more of the number of recording repeats, an accuracy of pronouncing a recorded content and the time to read the entire question passage, a frequency of underlining the learning materials, an underlining or note-taking speed, an interval between actions of the underlining or the note-taking and the amount of a pressure of the underlining, a speed of turning pages of the learning materials, a speed for inputting answers, a response speed of a learner to learning instructions, a frequency of moving pupils of the learner for a predetermined period of time, and the number of eye blinks for a predetermined time.

The pattern analyzer may calculate one or more of a first concentration level score set to vary depending on the number of repeats of a given question passage, a second concentration level score set according to closeness of pronunciation to a foreign language native speaker, and a third concentration level score set by the time to complete reading the entire question passage.

The learning materials may include one or more of works with an audio recording functionality for recording text and audio materials and learning materials for receiving an input of a learner by hand or a touch pen.

The analysis data may include a diagnosis output resulting from evaluating the trend of concentration level over time by using accumulated data for the interaction patterns for a predetermined period of time.

Further, according to another embodiment of the present disclosure, a method for analyzing learning plan includes: providing a learner with learning materials commensurate with a learning progress or learning ability; receiving learning information responsive to the learning materials; and generating analysis data by analyzing interaction patterns of a user in learning.

The analysis data may be calculated either by combining a correlation between the interaction patterns or by combining evaluation data of the learner calculated by automatically evaluating learning outputs included in the learning information based on a predetermined evaluation criteria with the correlation between the interaction patterns and the interaction patterns.

The analysis data may include a diagnosis output resulting from evaluating the trend of concentration levels over time by using an accumulation of the interaction patterns for a predetermined period of time.

The interaction patterns may be one or more of the number of recording repeats, an accuracy of pronouncing a recorded content and the time to read entire question passage, a frequency of underlining the learning materials, an underlining or note-taking speed, an interval between actions of the underlining or the note-taking and the amount of a pressure of the underlining, a speed of turning pages of the learning materials, a speed for inputting answers, a response speed of a learner to learning instructions, a frequency of moving pupils of the learner for a predetermined period of time, and the number of eye blinks for a predetermined time.

### ADVANTAGEOUS EFFECTS

According to the present disclosure as described above, interaction patterns of learning activities of a learner are collected and analyzed, and the analysis results including such as a learning concentration degree are fed back to the learner, which provides the learner with individualized and optimized learning conditions.

Calculating analysis data combined with a correlation between interaction patterns enables efficient diagnosis and provision of learning conditions, and the learner can be presented with an even more efficient learning conditions through producing analysis data by analyzing a learning attitude of the learner by combining evaluation data from evaluating the learning result and the learning pattern with the correlations between the evaluation data and the learning pattern.

The various aspects of the invention can provide analyses results of the learner's learning attitude in various ways and provide even more efficient learning conditions by exploiting the analysis results accumulated over time, by analyzing recorded patterns as in the case of analyzing learning patterns from the records conducted by using learning materials transmitted to the learner, analyzing the patterns as in the case that the user making underlines or taking notes using hand or a touch pen, and analyzing the speed of the user's response as in the case that the user can collect responses to the learning materials in learning.

### DESCRIPTION OF DRAWINGS

FIG. 1 is a block diagram for schematically showing a learning plan analysis system according to an embodiment of the present disclosure;

FIG. 2 is a block diagram for schematically showing a learning plan analyzer 120 according to an embodiment of the present disclosure; and

FIG. 3 is a flowchart for illustrating a method for analyzing learning plan in accordance with an embodiment of the present disclosure.

### REFERENCE NUMBERS

110: Terminal

120: Learning Plan Analyzer

122: Learning Materials Provider

124: Learning Information Receiver

125: Pattern Diagnosis DB

126: Evaluator

127: Evaluation DB

128: Pattern Analyzer

130: Wired/Wireless Network

### DETAILED DESCRIPTION

Hereinafter, embodiments of the present disclosure will be described in detail with reference to the accompanying drawings. In the following description, like reference numerals designate like elements although they are shown in different drawings. Further, in the following description of the present embodiments, a detailed description of known functions and configurations incorporated herein will be omitted for the purpose of clarity.

Additionally, in describing the components of the present disclosure, there may be terms used like first, second, A, B, (a), and (b). These are solely for the purpose of differentiating one component from the other but not to imply or suggest the substances, order or sequence of the components. If a component were described as ‘connected’, ‘coupled’, or ‘linked’ to another component, they may mean the components are not only directly ‘connected’, ‘coupled’, or ‘linked’ but also are indirectly ‘connected’, ‘coupled’, or ‘linked’ via a third component.

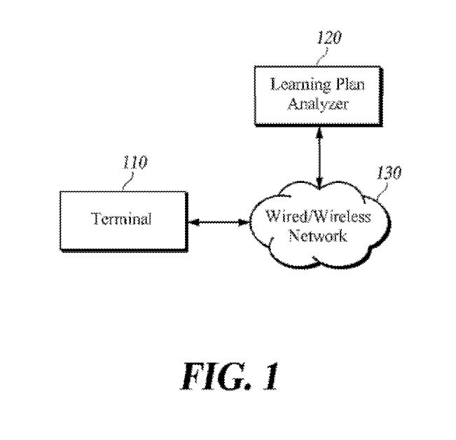

FIG. 1 is a block diagram for schematically showing a learning plan analysis system according to one or more embodiments of the present disclosure.

As shown in FIG. 1, the learning plan analysis system may include a terminal 110 and a learning plan analysis apparatus 120 which may be interconnected via a wired/wireless communication network or wire/wireless network 130. Learning plan analysis apparatus 120 may be used as a learning plan analysis server.

Terminal 110 is adapted to interwork with wired/wireless network 130 and connect to learning plan analysis apparatus 120 for transmitting and receiving various data. In addition, terminal 110 may be responsive to key manipulations of a user for connecting to learning plan analysis apparatus 120 via wired/wireless network 130 and receiving learning materials as well as transmitting learning information. Terminal 110 may be one of a personal computer (PC), notebook or laptop computer, personal digital assistant (PDA), portable multimedia player (PMP) and wireless communication terminal. It may be a designated learning terminal for online learning purpose, and may represent a variety of terminals including, for example, a memory for storing various programs such as a web browser for making connections with learning plan analysis apparatus 120 via wired/wireless network 130 and a microprocessor for executing the programs to perform operations and controls.

Terminal 110 receives learning materials via wired/wireless network 130 from learning plan analysis apparatus 120, and in response to the learner's input of the command to transmit information of finished learning by, for example, key operations on terminal 110, terminal 110 generates learning information including the outcome of learning and transmits the information to learning plan analysis apparatus 120.

Learning plan analysis apparatus 120 provides the terminal with the materials commensurate with a learning progress or learning ability, receives the learning information in response to the learner's input of the command to transmit the learning information generated from completing the learning by, for example, key operations on terminal 110, and then generates analysis data as a result of analyzing an interaction pattern of the received learning information. Here, the interaction pattern may mean the collection of learner's acts such as note taking or page turning performed immediately on the terminal where the learning materials are displayed or physical data collection from the learner in the learning session, including eye movements, gazing and the like.

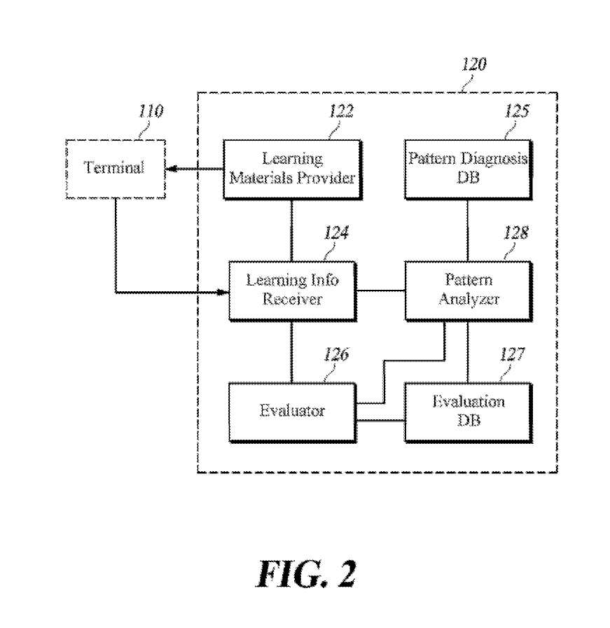

FIG. 2 is a block diagram for schematically showing a learning plan analyzer 120 according to one or more embodiments of the present disclosure.

As shown in FIG. 2, learning plan analysis apparatus 120 according to one or more embodiments may include a learning materials provider 122, a learning information receiver 124 and a pattern analyzer 128. It may further include an evaluator 126 where needed.

Learning materials provider 122 provides the learner with learning materials depending on the learner's progress in learning and learning capacity.

Learning information receiver 124 receives the learning information in reply to the learning materials which have been transmitted to the learner.

Pattern analyzer 128 generates analysis data by evaluating interaction pattern for the received learning information.

Evaluator 126 performs automatic evaluation by a preset evaluation criterion for the received learning information to compute learner's evaluation materials, when pattern analyzer 128 outputs its analysis data combined with the evaluation materials from evaluator 126.

Detailed description will continue with reference to FIGS. 1 and 2 together.

Learning plan analysis apparatus 120 may be provided with a lecture database (not shown) which stores the learner's learner information in one-to-one correspondence to teacher information such as assigned teacher, subjects, lecture time, personal information and the like and to respective relevant subjects and learning material information such as texts, multimedia materials and the like. The learner information may include learning subjects or courses, teacher, level of learning, level of achievement, test score and terminal information and the like.

Terminal 110 may be carried by the learner and provided with learning materials offered through downloading or other means via wired/wireless communication networks from learning plan analysis apparatus 120.

Provision of the learning materials from learning plan analysis apparatus 120 may be carried out by the learner who accesses the apparatus 120 by using a browser installed in terminal 110 and selects the learning materials to receive the selection. Alternatively, an internal scheduling unit (not shown) equipped in learning plan analysis apparatus 120 performs searching a lecture database (not shown) according to the learning schedule of the relevant subjects or teacher's assignments, acquires the student's terminal information and information on the learning materials and transmits the same information to the student's terminal.

Learning materials provider 122 provides terminal 110 with the lecture attendee's materials commensurate with individual learning progress or learning capacity.

The learner carrying the terminal 110 may carry out learning following certain instructions or guides contained in the learning materials received in terminal 110. The learning materials may be preparations and review materials or assessment problems submitted for evaluating the learner.

After finishing the learning materials via terminal 110, the learner may press a predetermined key on terminal 110 in order to upload learning information to learning plan analysis apparatus 120.

Learning information receiver 124 receives the learning information transmitted from the learner's terminal 110. The learning information may be an interaction pattern, or it may include the interaction pattern and learning outcome.

Pattern analyzer 128 evaluates the interaction pattern for the received learning information and generates analysis data.

In the meantime, along with the learner's outcome of learning the material, the interaction pattern may be transmitted from terminal 110 to learning information receiver 124.

If the learning material were in the format of a studying problem involving recorded data or texts to include listening comprehension and reading problems, the interaction pattern contained in the learning information may be the number of listening repeats of the listening comprehension problems or the number of reading repeats of the reading problems. Specifically, in the listening format that has the learner listen to a given question, comprehend the content and make a keyboard input on terminal 110, the interaction pattern of the number of listening repeats may be stored in terminal 110, and learning plan analysis apparatus 120, upon receiving the interaction pattern contained in the learning information from terminal 110, may refer to the interaction pattern received at pattern analyzer 128 to evaluate the comprehending level for the relevant problem and generate a diagnosis of the student.

For example, if questions set from the learning materials transmitted to terminal 110 are in the form of multiple listening comprehension problems, they may be set so that the respective problem questions in the learning materials have different problem types, and a pattern diagnosis DB 125 is set with an evaluation criterion that incorporates a detection of the learner's repeated listening trials of a single question in the learning session into analyzing the comprehending level for that question and such evaluation criterion preset and stored may be used as a basis for calculating the diagnosis information that is the outcome of the learner's performance of learning. For instance, if the student hears an item just once to check an answer, the questions of the corresponding problem type may be evaluated that they were easily comprehended by the learner, and as the more student repeats listening to the same item before inputting the answer, the lower response ability may be evaluated to the corresponding problem type and accordingly scored. The scoring criterion may differ by embodiments. The student's response abilities to the respective problem types of the learning materials may be stored in the lecture database (not shown) as learning history records of the corresponding learner.

In the event that learning plan analysis apparatus 120 transmits to terminal 110 the learning items by text designated for the student to learn, prompts the student to make voice recording with the use of terminal 110 and saves the voice record as a part of the outcome of learning, the number of repeated recording times may be set as an interaction pattern as is the designation of pronunciation accuracy of the recorded contents. In addition, the total time for reading the entire question passage given may be designated as an interaction pattern. With a predetermined pronunciation recognition program installed in learning plan analysis apparatus 120, the pronunciation accuracy may be scored by using the same program. Pattern analyzer 128 may generate one or more of the scored number of recording repeats, scored pronunciation accuracy of the recorded contents and scored total time for reading the question passages as analysis data and store the same in an evaluation DB 127.

In this way, the learning materials may be provided in a functional format to store relevant texts of the learning materials and audio records for giving the learner the functionality to record learner's reading of learning items. When terminal 110 is provided with the learning materials to direct the student to record verbal answers on terminal 110, terminal 110 may store the outcome of learning (possibly inclusive of the audio records) as well as interaction patterns which include the number of repeats of a given question passage, the total time for reading the entire question passage and the like. In this event, pattern analyzer 128 may evaluate the interaction patterns and generate an analytical material for producing a first concentration level score set to be inversely proportional to the number of repeats of the given question passage, a second concentration level score set according to closeness of pronunciation to a foreign language native speaker, and a third concentration level score set to be inversely proportional to the time to complete reading the entire question passage. The latter concentration level score in inverse proportion to the time for completely reading the entire question passage may be provided by adding durations of the respective reading trials or converted from a reading time of the fastest reading occasion. In addition, two of more of the first, second and third concentration level scores may be summed up to a converted concentration level in order to generate an analytical material. As in the above case, an evaluation criterion may be made into database for evaluating the first to third concentration level scores and the like and for storing in pattern diagnosis DB 125.

Meanwhile, terminal 110 may be provided with a device (for example touch screen) for allowing the learner to use fingers or a pen in underlining or note taking with the learning material output on terminal 110, sensing and storing the learner activities as the learning information. With the learning materials received by terminal 110 produced to have a functionality for accepting inputs of the learner who prepares and reviews by pen/hand touches on a screen of terminal 110, the student may use a pen/hand touch to make underlining or note taking on a screen of learning materials output on terminal 110, when one or more of the frequency of underlines or notes taken on the learning material, speed of underlining or note taking, interval between the actions of underlining or note taking and pressure of underling may be collected data as the interaction pattern of the learner and stored along with the outcome of learning into terminal 110. At the same time, the analysis data that are analyzed by pattern analyzer 128 may include a diagnosis result of evaluating the trend in concentration levels over time by using an accumulation of interaction patterns for a certain period of time.

In addition, if the received materials are learning materials for preparations and review, terminal 110 may store the amount of pressure of underlining or note taking with pen/hand touches during the learner's note taking or other learning activities, as an interaction pattern in terminal 110 and transmit the pattern and the outcome of learning together as learning information to learning plan analysis apparatus 120. Pattern analyzer 128 may analyze the frequency of underlines or notes taken on the learning material, speed of underlining/note taking, interval between the actions of underlining/note taking and pressure of underling and the like to calculate a pattern analysis result. For example, it may be evaluated that an increase of the frequency of underlines indicates increasing concentration level, a shorter interval between the actions of underlining/note taking also indicates increasing concentration level, and whereas increasing speed of underlining/note taking may be evaluated to mean decreasing concentration level. Further, a higher pressure of underling/note taking may be evaluated to reflect increasing concentration level. This evaluation criterion may differ by embodiments, and a variety of other evaluation criteria may be used.

In addition, possible interaction patterns to be stored with the outcome of learning as the learning information in terminal 110 may include a turning speed of pages of the learning materials, a speed for inputting answers, a response speed of the learner to learning instructions, for example to read supplement study materials as would occur in the course of learning. In this case, pattern analyzer 128 may collect the learner's response speed contained in the learning information as interaction pattern and analyze the trend of the patterns over time and thereby calculate the concentration level on learning. Specifically, it may calculate analysis data for determining that a higher turning speed of pages of the learning materials indicates improvement of the concentration level, a higher speed for inputting answers indicates increasing concentration level and a higher response speed of the learner to learning instructions indicates an enhanced concentration level. This evaluation criterion may differ by embodiments, and a variety of other evaluation criteria may be used.

With terminal 110 having a camera and program installed for recognizing the eyes of the learner, possible interaction patterns to be stored with the outcome of learning as the learning information may include a frequency of moving pupils of the learner and the number of eye blinks and the like. Off its camera images, terminal 110 may store the frequency of the pupils gazing out of a certain boundary of movements, the number of eye blinks for a predetermined time and the like together with the outcome of learning as interaction patterns. In this case, pattern analyzer 128 may collect the learner's pupil movements, eye blinks and other information contained in the learning information as interaction patterns and analyze the trend of the patterns over time and thereby calculate the concentration level on learning. The method of generating analysis data from the pupil movements or eye blinks may generate a variety of analysis data. For example, decreasing pupil movements may generate the analytical material that tells increasing concentration level while decreasing number of eye blinks for a predetermined time may have the analytical material indicating an improvement of the concentration level.

In addition, terminal 110 may store information of whether learning is performed on a learning material and the time of learning performed as interaction patterns, and the analytical material calculated by pattern analyzer 128 may include learning schedule compliance/noncompliance on the learning material and/or a learning diagnosis evaluated depending on the time of learning performed.

Pattern analyzer 128 performs a cumulative management of the concentration factors calculated as the interaction patterns, by storing the same in pattern diagnosis DB 125. Detecting and analyzing how the respective concentration factors change by time may define the learning pattern of the learner. Additionally, comparing a manageable evaluation result in the course of learning against the above factors may analyze their correlation. For example, with the speed for inputting answers increasing, if the calculation result of the learner's evaluation material rather indicates declined score as calculated by evaluator 126 through evaluating the outcome of learning contained in the learning information by the preset evaluation criterion, the concentration level may show a decrease in its analytical material. This correlative analytical method may vary its analytical process by embodiments. Therefore, based on the correlative analytical material between the learner's learning attitude and learning achievement, pattern analyzer 128 may recommend the proper time of day, way of learning and such to the learner.

If the abovementioned interaction pattern changes by the duration of learning, differences of the concentration level depending on the changed learning time may be calculated as the analytical material. For example, if an analysis of learning information received over a predetermined duration tells that materials that underwent learning in the night time have a high frequency of underlines while day time materials get a low frequency of underlines, then the night time learning may be determined to show higher level of concentration in an analytical material to be generated.

Though several examples of the interaction material have been illustrated, the present disclosure is not limited to the same and may detect various other interaction patterns of information on whether to generate word lists, whether to utilize wrong answer notes, learning time of day and the like so as to generate an analytical material for the learner.

As stated above, such information on the interaction patterns may be contained in the leaning information which learning information receiver 124 receives, and storing the interaction patterns within the learning information may be done as terminal 110 detects and stores the same in the learning information.

The analysis data derived by pattern analyzer 128 may include a learning diagnosis on courses taken and time of courses.

If an analysis of a learning pattern leads to determination that the level of difficulty be lowered, an advice may be provided to adjust the learning level down or recommended subjects may be presented in a setting stage. In addition, if an analysis of a learning pattern indicates changing concentration levels by learning time of day, a suggestion may be derived to encourage transferring the time to do learning. What is to determine the exact advice may depend on a diagnostic rule stored in pattern diagnosis DB 125 which holds the details for specifying the contents of the analysis data (e.g. recommended subject diagnosis) generated according to the analyzed interaction patterns.

On the other hand, learning plan analysis apparatus 120 may further include evaluator 126.

Evaluator 126 may calculate the learner's evaluation materials by automatically evaluating the received learning information by the preset evaluation criterion stored in an evaluation DB 127.

For example, if a material received from terminal 110 is an answer sheet for test questions, the answer sheet may be scored and its evaluation material may be calculated. Here, the test questions may include a test for past learning contents, test for questions during a lesson and the like. The evaluation material may be scores, a percentage of correct answers, other learners' percentages of correct answers, individual scores by chapter, academic field and assignment types, or it may be evaluation data for the outcome of learning.

The evaluation data for the outcome of learning may be the type of error-prone questions, trend of test scores, analysis of strong and weak points, overall score ranking and the like.

In this event, the analytical material generated by pattern analyzer 128 may be derived by combining the interaction patterns and the evaluation material calculated by evaluator 126.

Pattern analyzer 128 may refer to pattern diagnosis DB 125 and evaluation DB 127 for generating the combined diagnosis result.

For example, if the evaluation material calculated by evaluator 126 indicates excellence and the diagnosis material generated by pattern analyzer 128 indicates a presumably low concentration level, an advice may be issued for the learner to level up the course selection or to make a transfer to a course at higher level of difficulty.

This generation of the combined diagnosis in pattern analyzer 128 may be done through configuring pattern diagnosis DB 125 to store the criterion of combined diagnosis to which a reference is made, or a dedicated combined diagnosis DB (not shown) may be configured to store the criterion of combined diagnosis to be referenced. Storing different criteria will result in different diagnosis results and thus the suggested diagnosis results by the exemplary embodiments do not limit the present disclosure.

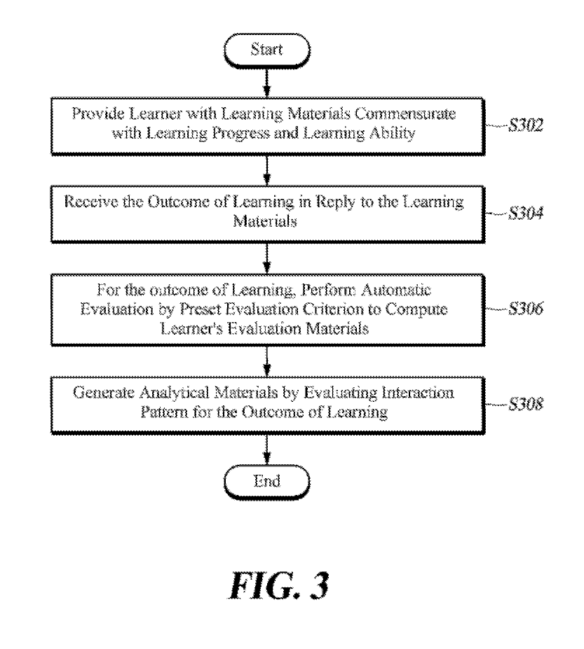

FIG. 3 is a flowchart for illustrating a method for analyzing learning plan in accordance with one or more embodiments of the present disclosure.

As FIG. 3 illustrates, the method for analyzing learning plan includes providing a learner with learning materials commensurate with learning progress and learning ability in step S302, receiving the outcome of learning in reply to the learning materials in step S304, with respect to the outcome of learning, performing an automatic evaluation by a preset evaluation criterion to compute learner's evaluation materials in step S306 and generating analysis data by evaluating interaction patterns for the learning information or outcome of learning in step S308.

The following description refers to FIGS. 1 to 3 together.

The process S306 may be omitted unless there are no learner's evaluation materials to be generated from receiving learning questions.

Here, the analysis data may be calculated by the correlation between the interaction patterns and the evaluation materials combined.

In addition, the analysis data may include a diagnosis result from evaluating the trend of concentration levels over time by using an accumulation of the interaction patterns for a predetermined period of time.

In addition, if the learning materials are provided in a functional format to store relevant texts of the learning materials and audio records, the interaction patterns may be one or more of the number of repeated recordings, the accuracy of pronunciation of the recorded contents and the total time for reading the entire question passage. The analysis data to be generated may be one or more of a first concentration level score set to depend on the number of repeats of the given question passage, a second concentration level score set according to closeness of pronunciation to a foreign language native speaker, and a third concentration level score set according to the time to complete reading the entire question passage.

If the learning materials are produced to have a functionality for accepting inputs of the learner who inputs by pen/hand touches on a provided screen, the interaction patterns may be set to be one or more of the frequency of underlines or notes taken on the learning material, speed of underlining or note taking, time interval between the actions of underlining or note taking and pressure of underling. At the same time, the analysis data may include a diagnosis result of evaluating the trend in concentration levels over time by using an accumulation of interaction patterns for a certain period of time.

Meanwhile, the interaction patterns may be set as one or more of a turning speed of pages of the learning materials, a speed for inputting answers, a response speed of a learner to learning instructions, a frequency of moving pupils of the learner for a predetermined period of time, and the number of eye blinks for a predetermined time. At the same time, the analysis data may include a diagnosis result of evaluating the trend in concentration levels over time by using an accumulation of interaction patterns for a certain period of time.

Further, the analysis data may be calculated by combining the same with the correlation between the interaction patterns.

In the description above, although all of the components of the embodiments of the present disclosure may have been explained as assembled or operatively connected as a unit, the present disclosure is not intended to limit itself to such embodiments. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in computer readable media, which in operation can realize the aspects of the present disclosure. The computer readable media may include magnetic recording media, optical recording media, and carrier wave media.

In addition, terms like ‘include’, ‘comprise’, and ‘have’ should be interpreted in default as inclusive or open rather than exclusive or closed unless expressly defined to the contrary. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although exemplary aspects of the present disclosure have been described for illustrative purposes, those skilled in the art will appreciate that various modifications, additions and substitutions are possible, without departing from essential characteristics of the disclosure. Therefore, exemplary aspects of the present disclosure have not been described for limiting purposes. Accordingly, the scope of the disclosure is not to be limited by the above aspects but by the claims and the equivalents thereof.

### INDUSTRIAL APPLICABILITY

As described above, the present disclosure has a substantial effect in industrial applicability among learning service providers for learners by collecting interaction patterns of learning activities and feeding analyzed learning attitudes back to the learners to present them with individualized and optimized learning conditions.

### CROSS-REFERENCE TO RELATED APPLICATION

If applicable, this application claims priority under 35 U.S.C §119(a) of Patent Application No. 10-2010-0082364, filed on Aug. 25, 2010 in Korea, the entire content of which is incorporated herein by reference. In addition, this non-provisional application claims priority in countries, other than the U.S., with the same reason based on the Korean Patent Application, the entire content of which is hereby incorporated by reference.

1. A system for analyzing a learning plan, the system comprising:
a terminal for receiving learning materials and generating a learning information; and
a server for providing the terminal with the learning materials commensurate with a learning progress or learning ability, receiving the learning information responsive to the learning materials and then generating analysis data by analyzing interaction patterns of learning by a user for the learning information.

2. An apparatus for analyzing a learning plan, the apparatus comprising:
a material provider for providing learning materials commensurate with a learning progress or learning ability through a predetermined terminal;
a learning information receiver for receiving learning information responsive to the learning materials; and
a pattern analyzer for generating analysis data from analyzing interaction patterns of a user in the course of learning, contained in the learning information.

3. The apparatus of claim 2, further including an evaluator for calculating evaluation data of the user in the course of learning by automatically evaluating learning outputs included in the learning information based on a predetermined evaluation criterion.

4. The apparatus of claim 3, wherein the analysis data is calculated by combining a correlation between the interaction patterns and the evaluation data.

5. The apparatus of claim 2, wherein the interaction patterns are one or more of the number of recording repeats, an accuracy of pronouncing a recorded content and the time to read the entire question passage, a frequency of underlining the learning materials, an underlining or note-taking speed, an interval between actions of the underlining or the note-taking and the amount of a pressure of the underlining, a speed of turning pages of the learning materials, a speed for inputting answers, a response speed of a learner to learning instructions, a frequency of moving pupils of the learner for a predetermined period of time, and the number of eye blinks for a predetermined time.

6. The apparatus of claim 2, wherein the pattern analyzer calculates one or more of a first concentration level score set to vary depending on the number of repeats of a given question passage, a second concentration level score set according to closeness of pronunciation to a foreign language native speaker, and a third concentration level score set by the time to complete reading the entire question passage.

7. The apparatus of claim 2, wherein the learning materials are one or more of works with an audio recording functionality for recording text and audio materials and learning materials for receiving an input of a learner by hand or a touch pen.

8. The apparatus of claim 2, wherein the analysis data includes a diagnosis output resulting from evaluating a trend of concentration levels over time by using accumulated data for the interaction patterns for a predetermined period of time.

9. A method for analyzing learning plan, the method comprising:
providing a learner with learning materials commensurate with a learning progress or learning ability;
receiving learning information responsive to the learning materials; and
generating analysis data by analyzing interaction patterns of a user in the course of learning.

10. The method of claim 9, wherein the analysis data is calculated by combining evaluation data of the learner calculated by automatically evaluating learning outputs included in the learning information based on a predetermined evaluation criteria with a correlation between the evaluation data and the interaction patterns.

11. The method of claim 9, wherein the analysis data includes a diagnosis output resulting from evaluating a trend of concentration levels over time by using an accumulation of the interaction patterns for a predetermined period of time.

12. The method of claim 9, wherein the interaction patterns are one or more of the number of recording repeats, an accuracy of pronouncing a recorded content and the time to read the entire question passage, a frequency of underlining the learning materials, an underlining or note-taking speed, an interval between actions of the underlining or the note-taking and the amount of a pressure of the underlining, a speed of turning pages of the learning materials, a speed for inputting answers, a response speed of a learner to learning instructions, a frequency of moving pupils of the learner for a predetermined period of time, and the number of eye blinks for a predetermined time.
